(19) United States
(12) Patent Application Publication
(10) Pub. No.: US 2003/0102286 A1
(43) Pub. Date: Jun. 5, 2003

(54) Surface treatment process

(76) Inventors: Koji Takahara, Osaka (JP); Hiroshi Toyota, Kawaguchi-shi (JP)

Correspondence Address: MCDERMOTT WILL & EMERY, 600 13TH STREET, N.W., WASHINGTON, DC, 20005-3096, US

(21) Appl. No.: 10/239,563

(22) PCT Filed: Mar. 19, 2001
(86) PCT No.: PCT/JP01/02196

(30) Foreign Application Priority Data
Mar. 24, 2000 (JP) 2000-88524

(51) Int. Cl. C23F 1/00; B44C 1/22; C03C 15/00; C03C 25/68

(52) U.S. Cl. 216/45

(57) ABSTRACT

On an optical device, a metal mask is formed in the shape of a dot array, and then reactive ion etching is performed. The etching is continued while the diameter of the metal mask gradually becomes smaller until the area of the metal reduces to a predetermined area. This produces on the optical device a conical shape with a high aspect ratio, realizing an anti-reflection structure that exerts an anti-reflection effect on light spreading in a range of wavelengths wider than ever and that depends less on the angle of incidence

### TECHNICAL FIELD

The present invention relates to a surface treatment process, and particularly to a surface treatment process for forming an anti-reflection coating on a surface of an optical device.

### BACKGROUND ART

Conventionally, an optical device formed out of glass or the like is subjected to surface treatment in order to reduce returning light due to surface reflection and to increase transmitted light. One practical surface treatment process involves forming an anti-reflection film consisting of a single or multiple layers of thin-film substances, i.e., thin films of dielectrics, on a surface of an optical device. This process has long been practiced, and typically relies on a film formation process such as vacuum deposition to form such thin films.

Specifically, a thin film consisting of a single layer of a low-refractive-index substance formed on a surface of an optical device exerts an anti-reflection effect on light of a single wavelength. On the other hand, a thin film consisting of a plurality of layers of low- and high-refractive-index substances formed alternately exert an anti-reflection effect on light spreading in a range of wavelengths. By forming more layers, it is possible to widen the range of wavelengths of the light on which the anti-reflection effect is exerted.

Instead of forming a thin film consisting of a single layer of a low-refractive-index substance, it is also possible to form a film having fine particles of a low-refractive-index substance dispersed therein, or a porous film, or the like. These methods do not require large-scale equipment such as an apparatus for vacuum deposition.

Another practical surface treatment process involves forming fine depressions and elevations densely on a surface of an optical device. In general, when light passes through a surface of an optical device having depressions and elevations formed in a periodic pattern thereon, diffraction occurs, greatly reducing the proportion of straight light in the transmitted light. However, if the pitch of the depressions and elevations is shorter than the wavelength of the transmitted light, no diffraction occurs, and, by making the depressions and elevations, for example, rectangular as will be described later, it is possible to produce an anti-reflection effect on light of a single wavelength corresponding to the pitch and depth of those depressions and elevations.

Furthermore, by making the depressions and elevations not rectangular but conical as will be described later so that the ratio of the crest-side volume (occupied by the material of the optical device) to the trough-side volume (occupied by air) varies continuously, it is possible to produce an anti-reflection effect on light spreading in a wide range of wavelengths.

As a practical method for producing such a shape, for example, Japanese Patent Application Laid-Open No. H5-88001 proposes a method for forming an anti-reflection film on the outer surface of the face portion of a cathode ray tube. In this method, first, an alcohol solution of a silicate, in which fine particles 1 to 10 μm across coated with a material soluble in and thus removable with a solvent other than alcohol are dispersed, is applied to the outer surface of the face portion so that a coating layer is formed thereon that is composed of the silicate and the coated fine particles. Then, this coating layer is cleaned with the aforementioned solvent to dissolve the material coating the fine particles. As a result, the fine particles are removed, and thus the coating layer remains in the form of a film of the silicate having depressions and elevations.

Specifically, first an alcohol solution of ethyl silicate mixed with fine particles of silicon oxide or aluminum oxide is applied to a surface of an optical device, and then the fine particles are removed to obtain a film having depressions and elevations.

As another example, Japanese Patent Application Laid-Open No. H7-98401 proposes an anti-reflection film including a fluorine-added layer having a refractive index of 1.40 or lower and having, on the incident-side surface thereof, fine depressions and elevations formed as a large number of patches of depressed and elevated surfaces with a height or depth of 40 to 200 nm and a maximum horizontal length of 200 nm.

As another example, Japanese Patent Application Laid-Open No. S63-248740 proposes forming an SiO₂ film having fine depressions and elevations by applying an alcohol solution of Si(OR)₄ having a metal ingredient added thereto to a glass surface, then calcinating it to form a coating film, then removing the metal ingredient contained in the coating film by etching.

As another example, Japanese Patent Application Laid-Open No. S62-96902 proposes forming the surface of a mold into a dense sawtooth-like shape (the peaks may be round) with a predetermined depth in the range of from 1/3 to 1/50 of the wavelengths of visible light, and then molding a plastic material with that mold.

As another example, U.S. Pat. No. 4,344,816 proposes forming a hill-like shape by vapor-depositing a poorly wettable material on a substrate, and then transferring it to the substrate by anisotropic etching such as reactive ion etching (RIE) to obtain a quasi-conical shape.

As another example, U.S. Pat. No. 5,312,514 proposes producing a conical shape on a substrate by performing ion etching exploiting, as a masking material, the discontinuous insular structure of nuclei formed when a very thin film is formed by vapor deposition or sputtering.

However, by the method described above of forming an anti-reflection film consisting of thin films of dielectrics on a surface of an optical device, it is difficult, with a moderate number of dielectric thin films, to produce an anti-reflection effect on light spreading in a range of wavelengths. To produce an anti-reflection effect on light spreading in a wide range of wavelengths, it is necessary to form a considerable number of dielectric thin films. Moreover, to reduce the variation of the refractive index according to the angle of incidence of light, it is necessary to form still more dielectric thin films. Thus, depending on the performance required, it may be necessary to form as many as more than ten to several tens of layers.

An anti-reflection film, in principle, cancels returning light by exploiting interference of light, and therefore, when the individual dielectric thin films thereof are formed, it is necessary to control the refractive indices of the materials and the film thicknesses with high accuracy. Thus, the larger the number of layers of the thin films formed, the higher the costs. Moreover, the larger the number of layers of the thin films formed, the more likely the substrate, i.e., the base of the optical device, develops a warp, lowering the yield.

By the method described above of forming fine depressions and elevations densely on a surface of an optical device, as shown in a schematic vertical sectional view in FIG. 9, when a rectangular grating 1a is formed on an optical substrate 1, it is possible to produce an anti-reflection effect on light of a single wavelength corresponding to the pitch “p”, depth “L,” and other parameters of the grating, but it is difficult to produce an anti-reflection effect on light spreading in a range of wavelengths.

This can be improved, as shown in a schematic vertical sectional view in FIG. 10, by forming, instead, conical projections 1b on the optical substrate 1. To produce an anti-reflection effect on light spreading in a wider range of wavelengths, it is desirable to make the aspect ratio of the projections 1b, i.e., the ratio of the height “A” to the pitch “P” thereof, as high as possible. However, by the methods proposed in Japanese Patent Application Laid-Open No. H5-88001 and Japanese Patent Application Laid-Open No. H7-98401, both mentioned above, it is inherently difficult to form a conical shape having an aspect ratio of 1 or higher.

By the methods proposed in Japanese Patent Application Laid-Open No. S63-248740 and Japanese Patent Application Laid-Open No. S62-96902, both mentioned above, the projections produced may have irregular shapes, causing irregular reflection of incident light and thus leading to lower efficiency.

By the method proposed in U.S. Pat. No. 4,344,816 mentioned above, a hill-like shape is transferred, and therefore a difference in etching rate between the substrate and the mask produces a longitudinally extended shape. However, it is difficult to form a shape with pointed peaks. Moreover, since this method exploits the low wettability between the substrate and the mask, to form films with satisfactory repeatability, it is necessary to strictly control the film formation rate and the degree of vacuum.

By the method proposed in U.S. Pat. No. 5,312,514 mentioned above, it is possible to form a shape with pointed peaks, but, as the film thickness of the mask is made greater, insular elevations get connected with one other, forming a continuous film. Thus, it is difficult to produce a mask with a film thickness of 100 Å or more. Quite naturally, it is difficult to form a conical shape with a high aspect ratio, and therefore this method, when used for anti-reflection surface treatment, does not offer satisfactory performance in a longer-wavelength range.

Moreover, by the methods proposed in U.S. Pat. No. 4,344,816 and U.S. Pat. No. 5,312,514, it is difficult to form films with satisfactory repeatability, and to control the height and pitch of depressions and elevations or vary them from one place to another as required.

### DISCLOSURE OF THE INVENTION

An object of the present invention is to provide a surface treatment process for forming on an optical device a conical shape with a high aspect ratio for the purpose of realizing an anti-reflection structure that exerts an anti-reflection effect on light spreading in a range of wavelengths wider than ever and that depends less on the angle of incidence.

To achieve the above object, according to the present invention, a surface treatment process includes forming a mask in the shape of a dot array on a treated member and then etching the mask. Here, a conical shape is formed on the treated member by etching the treated member while the diameter of the mask gradually becomes smaller until the area of the mask reduces to a predetermined area.

The etching may be achieved by reactive ion etching. The reactive ion etching may be performed using a high-density plasma etching apparatus having, as separate units independent of each other, a high-frequency introduction portion for generating plasma and a high-frequency introduction portion for introducing ions into a substrate.

The mask may be made of a metal selected from Cr and Al. The mask may have a thickness of from 100 to 1,000 Å. The proportion of the area of the mask formed in the shape of a dot array may be from 25 to 95%. The mask may be formed with a pitch calculated by dividing the target wavelength by the refractive index of the treated member. Here, the target wavelength denotes the wavelength of the light that is shone at the surface-treated portion of the optical device.

The reactive ion etching may be performed using CHF₃ as a reactive gas. Alternatively, the reactive ion etching may be performed using as a reactive gas a mixture of C₄F₈ and CH₂F₂ in a predetermined ratio. In this case, the proportion of CH₂F₂ in the reactive gas may be from 10 to 50%.

The treated member may be an optical device. The treated member may be made of quartz glass.

### BRIEF DESCRIPTION OF DRAWINGS

FIGS. 1A, 1B, 1C, and 1D are vertical sectional views schematically showing an example of the process of forming a metal mask in the shape of a dot array on an optical device.

FIG. 2 is a plan view showing the metal mask formed in the shape of a dot array.

FIG. 3 shows the relationship between the proportion of the remaining portion of the mask and the reflectivity (calculated) for incident light of different wavelengths.

FIGS. 4A and 4B are vertical sectional views schematically showing an example of the process of performing reactive ion etching on an optical device having a metal mask formed in the shape of a dot array.

FIG. 5 is a vertical sectional view schematically showing an example of an etching apparatus using high-density plasma.

FIG. 6 is a diagram schematically showing the proportion of the aria occupied by a dot per unit area occurring in a two-dimensional periodic pattern.

FIG. 7 is a graph showing the reflectance spectral characteristics of an anti-reflection structure having a conical shape formed on a quartz glass substrate according to the invention.

FIG. 8 is a perspective view schematically showing the conical projections formed on an optical substrate by the process according to the invention.

FIG. 9 is a vertical sectional view schematically showing a structure having a rectangular grating formed on an optical substrate.

FIG. 10 is a vertical sectional view schematically showing a structure having conical projections formed on an optical substrate.

FIG. 11 is a vertical sectional view schematically showing an example of etching performed with a small difference in etching rate between the substrate and the mask.

FIG. 12 is a vertical sectional view schematically showing an example of etching performed with a large difference in etching rate between the substrate and the mask.

### BEST MODE FOR CARRYING OUT THE INVENTION

Hereinafter, an embodiment of the present invention will be described with reference to the drawings. According to the invention, a metal mask is formed in the shape of a dot array on an optical device, and then reactive ion etching is performed so that the optical device is etched while the diameter of the metal mask gradually becomes smaller until the metal mask disappears. In this way, a conical shape is formed on the optical device.

When reactive ion etching is performed using an etching mask, the electric field concentrates at edged portions where the top end of the mask is selectively etched. As a result, the edges are rounded, giving the top portion of the mask a rounded shape. This phenomenon is called the edge effect.

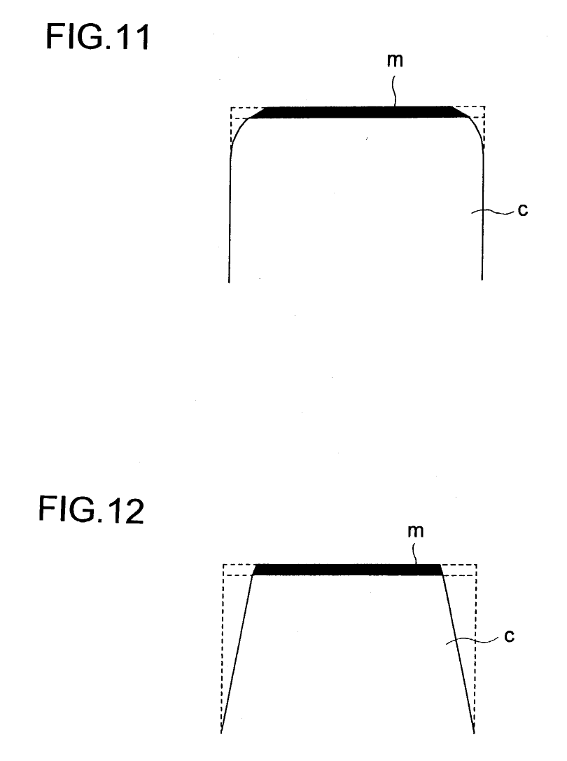

This phenomenon will be described with reference to FIGS. 11 and 12. When the etching rate of the mask almost equals that of the substrate, as shown in FIG. 11, the peripheral portion of the mask m is rounded along with the substrate c below it, and thus the diameter of a dot reduces only to a certain degree. However, when a material of which the etching rate is markedly lower than that of the substrate, such as a metal thin film, is used as the mask, the substrate c alone is etched at a high rate, keeping the peripheral portion of the mask m edged as shown in FIG. 12.

As a result, the mask m is etched at a higher rate laterally than in the direction of the film thickness thereof, and thus the mask m, in the shape of a dot, gradually becomes smaller toward the center. Meanwhile, the substrate c also is etched continuously, and thus, when the mask m disappears completely, a conical shape with an extremely pointed peak remains. The mask is preferably made of a metal that is etched at a lower rate than an optical material such as glass and that can easily be formed into a film, specifically Cr or Al.

The mask is produced by a common process based on the technology of photolithography and the lift-off technique. Alternatively, it is also possible to produce a mask having dots arranged at extremely short regular intervals in a periodic pattern by direct formation using an electron beam or by interference exposure using two or three beams.

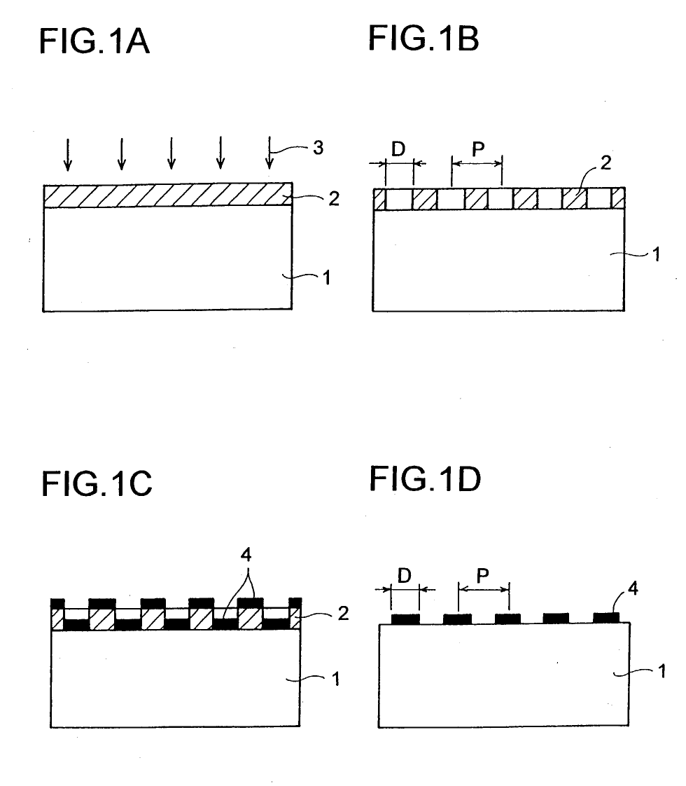

FIG. 1 shows vertical sectional views schematically showing an example of the process of forming a metal mask in the shape of a dot array on an optical device. First, as shown in FIG. 1A, on an optical substrate 1 made of quartz, glass, or the like, a positive electron beam resist 2 is formed so as to have a thickness of about 3,000 Å by spin coating, and then, as indicated by arrows, an electron beam 3 is shone on it so as to describe circles with a diameter of 125 nm and a pitch of 250 nm. Next, as shown in FIG. 1B, those portions of the electron beam resist 2 which have been irradiated with the electron beam are removed by development. The diameter and pitch of those portions are represented by “D” and “P.”

Then, as shown in FIG. 1C, a metal 4 such as Cr or Al is vapor-deposited so as to have a thickness of about 500 Å. Here, the metal 4 is vapor-deposited on the electron beam resist 2 and also on the optical substrate 1 where the electron beam resist 2 has been removed. Lastly, as shown in FIG. 1D, the electron beam resist 2 is completely removed by lift-off. Now, only the metal 4 vapor-deposited on the optical substrate 1 remains. This is used as a metal mask. If the resist, not the metal mask, is used as a mask, its film thickness reduces at so high a rate that it is difficult to form a conical shape.

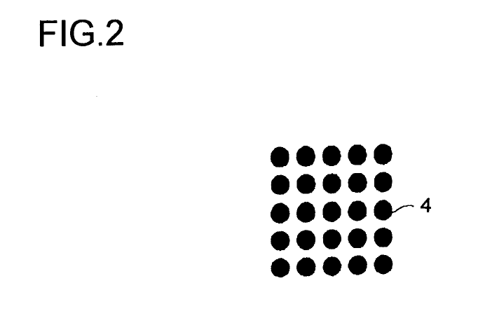

This metal mask, when observed in a plan view, has the metal 4 arranged in the shape of a dot array as shown in FIG. 2. The shape of these dots does not necessarily has to be circular, but may be rectangular, or of any other polygonal shape or the like. The thickness of the metal mask is adjusted to from 100 to 1,000 Å. If the film thickness is too small, the mask disappears before the diameter thereof reduces sufficiently, making the sectional shape after etching trapezoidal. That is, it is difficult to form a conical shape. On the other hand, when the film thickness is too large, it takes too much time for the mask to disappear, leading to low efficiency. For these reasons, it is preferable that the metal mask have a thickness of from 100 to 1,000 Å as described above.

There is no particular restriction on the edges of the mask formed on the substrate; for example, the edges may have rectangular sections as shown in FIG. 1D.

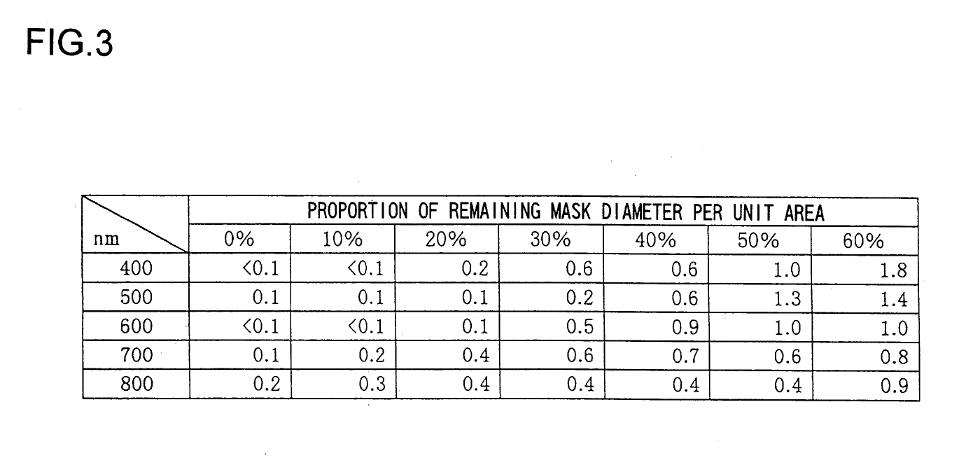

Etching does not necessarily have to be performed until the metal mask disappears completely. FIG. 3 shows the relationship between the proportion of the remaining portion of the mask and the reflectivity (calculated) for incident light of different wavelengths as observed when surface treatment is performed with a mask pitch of 250 nm in such a way that a grating depth of 500 nm is obtained when the dots disappear. Here, it is to be noted that, for the results obtained with mask diameters other than 0%, the grating depths are corrected to be smaller according to the proportion of the remaining portion of the mask.

In general, satisfactory anti-reflection treatment requires a reflectivity lower than 1%. According to FIG. 3, when the proportion of the remaining diameter of the mask is 50%, a reflectivity of about 1% is obtained throughout the range of visible light. Thus, it can safely be said that, with the proportion of the remaining diameter of the mask lower than 50%, it is possible to produce a satisfactory anti-reflection effect in practical terms.

The pitch of the metal mask is adjusted to from 100 to 300 nm. It is advisable that this pitch be equal to or smaller than the wavelength of target light (called the target wavelength) divided by the refractive index of the treated member (here, the optical substrate 1). Here, the target light denotes the light that is shone at the anti-reflection structure having a conical shape produced in this embodiment.

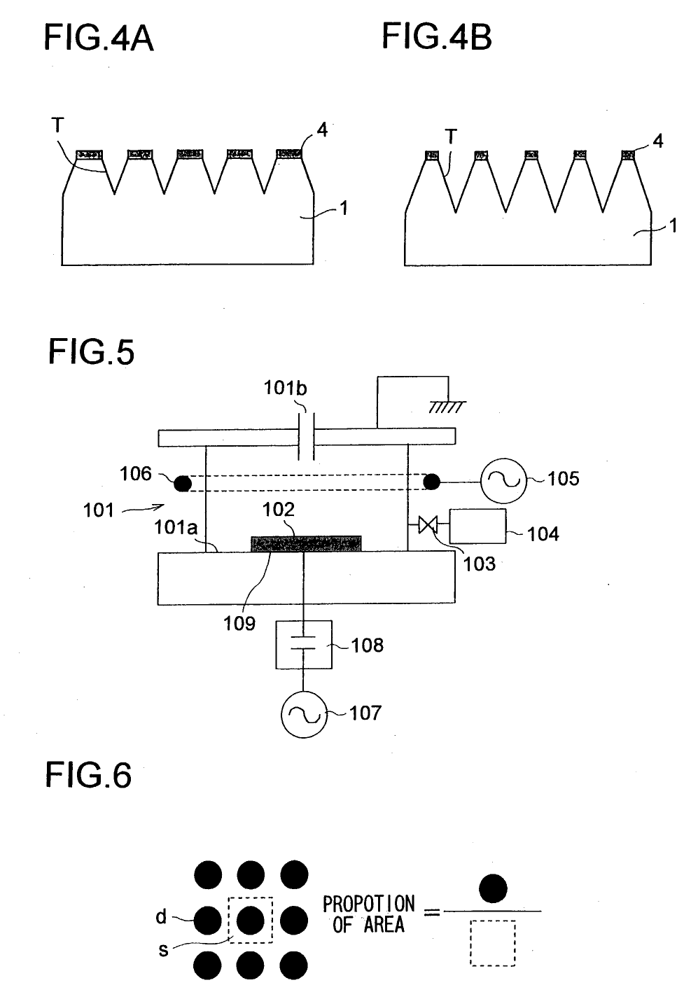

FIG. 4 shows vertical sectional views schematically showing an example of the process of performing reactive ion etching on an optical device having a metal mask formed in the shape of a dot array. An optical substrate 1 having a metal 4 vapor-deposited thereon in the shape of a dot array as described above is placed inside an apparatus for reactive ion etching, and etching is performed in a flow of a reactive gas.

A suitable example of the etching apparatus used here is a high-density plasma etching apparatus as shown in FIG. 5 having, as separate units independent of each other, a high-frequency introduction portion for generating plasma and a high-frequency introduction portion for introducing ions into a substrate. With this apparatus, the substrate is not exposed directly to plasma, and it is possible to make higher the ratio of the etching rate of the substrate to that of the mask in the film thickness direction thereof. Moreover, the apparatus permits etching with a lower degree of vacuum than a common etching apparatus, and thus it is possible to perform etching with better directivity, and to obtain a better conical shape. Moreover, the apparatus permits sufficient introduction of ions into the substrate to make the diameter of the mask reduce gradually, and therefore it is possible to make the diameter of even a mask with a film thickness of 100 Å or more reduce gradually, and to obtain a conical shape with a high aspect ratio.

Specifically, a substrate 102 to be subjected to surface treatment is placed on a bottom surface 101a inside a vacuum chamber 101, and then the gas inside the vacuum chamber 101 is exhausted via a valve 103 by an exhaust pump 104. Then, a reactive gas is introduced via a gas introduction inlet 101b at the top of the vacuum chamber 101, and a high-frequency wave is generated by a high-frequency introduction portion 105 from a coil 106 wound around the vacuum chamber 101 so that the reactive gas is excited into plasma inside the vacuum chamber 101. On the other hand, a high-frequency wave is applied also to an electrode 109 holding the substrate 102 by another high-frequency introduction portion 107 through an impedance matcher 108 for matching impedances. This serves as a self bias that causes ions inside the vacuum chamber 101 to be introduced into the substrate 102, prompting the etching of the substrate 102 in the vertical direction.

Here, as the reactive gas, a mixture of C₄F₈ and CH₂F₂ in a predetermined ratio is used. Instead, CHF₃ may be used singly.

The etching is performed under the following conditions:

Gas Pressure: 0.5 Pa

Antenna Power: 1,500 W

Bias Power: 450 W

C₄F₈/ CH₂F₂: 16/14 sccm

Etching Duration: 60 sec

Here, the antenna power denotes the high-frequency power applied to an antenna inside the apparatus to generate plasma, and the bias power denotes the high-frequency power applied to introduce ions present in the plasma into the optical substrate. The unit sccm is short for “standard cubic centimeter per minute.” The proportion of CH₂F₂ in the reactive gas is adjusted to from 10 to 50%. Here, if the concentration of CH₂F₂ is too low, the etched shape, which will be described later, has too large a taper angle, resulting in an aspect ratio lower than 1. On the other band, if the concentration of CH₂F₂ is too high, the tapered portion becomes not V-shaped but U-shaped. For these reasons, it is preferable that the proportion of CH₂F₂ in the reactive gas be from 10 to 50% as described above.

When reactive ion etching is started under the conditions described above, first, as shown in FIG. 4A, the optical substrate 1 starts being etched into a tapered shape T, starting in the portions thereof where the metal 4 (metal mask) does not cover it. Then, as shown in FIG. 4B, while the metal mask itself is also etched gradually with its diameter becoming smaller and smaller, the optical substrate 1 is etched further. When the etching is continued until the metal mask disappears, projections having a conical shape as shown in FIG. 10 are formed. In this embodiment, conical projections 1b are obtained with a pitch “P” of about 250 nm and a height “A” of about 750 nm.

In this process, it is necessary to give sufficient consideration to the relationship between the cross-sectional area of dots and the intervals between them. In principle, the individual dots need to be away from one another, but, if the area of the mask is too small relative to the intervals between the dots, the height of the conical shape obtained is too small, or there remains too large a flat area around the conical shape, in either case leading to unsatisfactory performance. Through experiments, it has been found out that, for effective results, the proportion of the area of the dot-shaped mask needs to be from 25 to 95%. With less than 25%, it is impossible to obtain a satisfactorily low reflectivity; with more than 95%, the substrate is not etched easily, making the production process difficult. Here, the proportion of the area denotes, as shown in FIG. 6, the proportion of the aria occupied by a dot “d” per unit area “s” occurring in a two-dimensional periodic pattern.

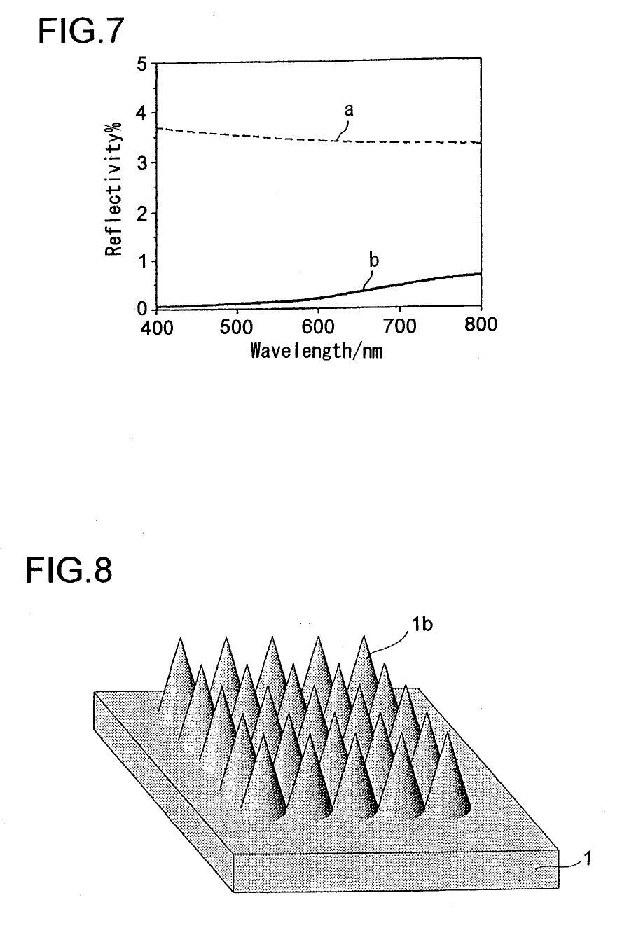

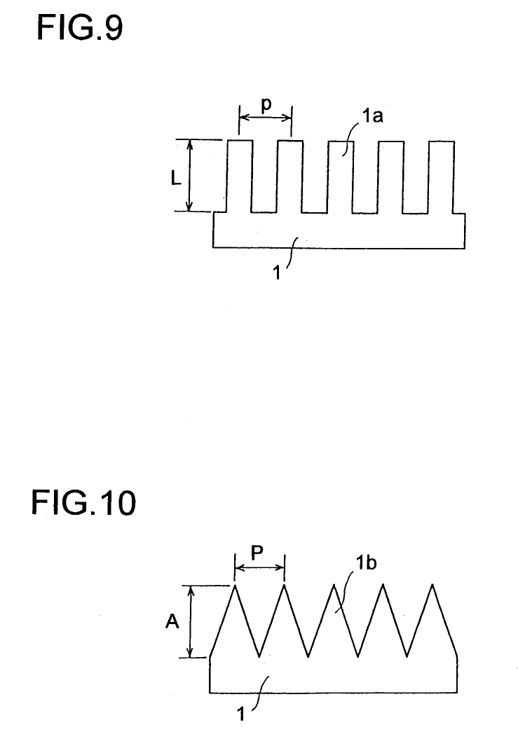

FIG. 7 is a graph showing the reflectance spectral characteristics of the anti-reflection structure having a conical shape formed on a quartz glass substrate according to this embodiment. In this figure, the wavelength (nm) is taken along the horizontal axis, and the reflectivity (%) is taken along the vertical axis. The broken line “a” represents the characteristic of quartz glass alone, and the solid line “b” represents the characteristic of the optical device according to the invention. As shown in this figure, whereas quartz glass alone exhibits a reflectivity as high as more than 3% for visible light spreading in the wide range of from 400 to 800 nm, the optical device according to the invention exhibits a satisfactorily low reflectivity of 0.6% or lower.

The material of the treated member on which the anti-reflection structure is formed is not limited to quarts glass. The surface treatment according to the invention may be performed on a metal mold so that, with this mold, an optical device having similar functions as those obtained in this embodiment is produced. FIG. 8 is a perspective view schematically showing the conical projections 1b formed on the optical substrate 1 by the process according to the invention.

Obviously, many modifications and variations of the present invention are possible in light of the above teachings. It is therefore to be understood that within the scope of the appended claims, the invention may be practiced other than as specifically described.

Industrial Applicability

As described above, according to the present invention, it is possible to provide a surface treatment process for forming on an optical device a conical shape with a high aspect ratio for the purpose of realizing an anti-reflection structure that exerts an anti-reflection effect on light spreading in a range of wavelengths wider than ever and that depends less on the angle of incidence.

1. A surface treatment process including forming a mask in a shape of a dot array on a treated member and then etching the mask,
wherein a conical shape is formed on the treated member by etching the treated member while a diameter of the mask gradually becomes smaller until an area of the mask reduces to a predetermined area.

2. A surface treatment process as claimed in claim 1,
wherein the etching is achieved by reactive ion etching.

3. A surface treatment process as claimed in claim 2,
wherein the reactive ion etching is performed using a high-density plasma etching apparatus having, as separate units independent of each other, a high-frequency introduction portion for generating plasma and a high-frequency introduction portion for introducing ions into a substrate.

4. A surface treatment process as claimed in claim 2,
wherein the mask is made of a metal selected from Cr and Al.

5. A surface treatment process as claimed in claim 2,
wherein the mask has a thickness of from 100 to 1,000 Å.

6. A surface treatment process as claimed in claim 2,
wherein a proportion of the mask formed in the shape of a dot array is from 25 to 95%.

7. A surface treatment process as claimed in claim 2,
wherein the mask is formed with a pitch calculated by dividing a target wavelength by a refractive index of the treated member.

8. A surface treatment process as claimed in claim 2,
wherein the reactive ion etching is performed using CHF₃ as a reactive gas.

9. A surface treatment process as claimed in claim 2,
wherein the reactive ion etching is performed using as a reactive gas a mixture of C₄F₈ and CH₂F₂ in a predetermined ratio.

10. A surface treatment process as claimed in claim 9,
wherein a proportion of CH₂F₂ in the reactive gas is from 10 to 50%.

11. A surface treatment process as claimed in claim 1,
wherein the treated member is an optical device.

12. A surface treatment process as claimed in claim 2,
wherein the treated member is an optical device.

13. A surface treatment process as claimed in claim 1,
wherein the treated member is made of quartz glass.

14. A surface treatment process as claimed in claim 2,
wherein the treated member is made of quartz glass.
